(19) United States
(12) Patent Application Publication
(10) Pub. No.: US 2011/0013612 A1
(43) Pub. Date: Jan. 20, 2011

(54) Protocol Coexistence

(75) Inventor: Alexander Thoukydides, Cambridge (GB)

Correspondence Address: Novak Druce DeLuca + Quigg LLP (CSR), 300 New Jersey Avenue, NW, Fifth Floor, Washington, DC, 20001, US

(73) Assignee: CAMBRIDGE SILICON RADIO LIMITED, Cambridge (GB)

(21) Appl. No.: 12/919,746

(22) PCT Filed: Mar. 12, 2009
(86) PCT No.: PCT/EP2009/052947

§ 371 Date: Sep. 23, 2010

(30) Foreign Application Priority Data
Mar. 12, 2008 (GB) 0804615.3

(51) Int. Cl. H04W 84/02

(52) U.S. Cl. 370/338

(57) ABSTRACT

A communication device having: a first communication unit for transmitting and/or receiving by a first protocol acknowledgements for data received by the device; a second communication unit for transmitting data units of a second protocol, the first and second protocols being such that the data units of the second protocol can interfere with the acknowledgements of the first protocol; and a controller configured to control the device such that, when a data unit of the second protocol is being transmitted by the second communication unit and the first communication unit is to transmit or receive an acknowledgement of the first protocol: the second communication unit interrupts the transmission of the data unit of the second protocol, the first communication unit transmits or receives the acknowledgement of the first protocol and the second transmitter resumes transmission of the data unit of the second protocol from the point that transmission of the data unit would have reached if it had not been interrupted.

This invention relates to coexistence between protocols, for example between wireless LAN (local area network) protocols and other protocols that overlap their frequency space.

The ISM (industrial, scientific and medical) frequency band is used by many protocols and types of device. One set of protocols that use the ISM band is the IEEE 802.11 wireless LAN protocols. An example of another protocol that uses the ISM bands is Bluetooth. The following description will concentrate on issues of coexistence between 802.11 and Bluetooth but the approach described below is applicable to other pairs of protocols that mutually interfere, or to coexistence between protocols used in a device that cannot support full operation with both protocols simultaneously.

According to 802.11 protocols data is transmitted from a transmitter to a receiver and the receiver then acknowledges that data by sending an ACK packet back to the transmitter. If the transmitter does not receive the ACK packet then it will assume that the data has not been received and it will implement mechanisms built into the protocols to ensure that the data is received. Those mechanisms include retransmission of the data, exponential back-off and data rate reduction. All of those mechanisms reduce the throughput of data from the transmitter to the receiver.

If the transmitter does not receive an ACK for some data it has sent then it may be because the data was not received by the receiver. Or it may be because the data was received by the receiver but the ACK that the receiver then sent was not successfully detected by the transmitter. The transmitter cannot distinguish between these two possibilities.

In some devices an 802.11 receiver is co-located with a transmitter for another protocol that uses the frequency band that is used by 802.11. In that situation, one reason why 802.11 ACKs sent by the receiver might fail to be received by the 802.11 transmitter is that they suffer interference from the co-located transmitter. Similar problems can arise if in the device the transmitter for the other protocol shares some signal processing or transmission components (e.g. an amplifier, a mixer or an antenna) with the 802.11 transmitter, with the result that only one of the transmitters can operate at any one time. To avoid the possibility of 802.11 throughput being degraded in such a device it is necessary to implement some coexistence mechanism that co-ordinates the co-located transmitter's activities with the sending of ACKs by the 802.11 receiver.

That co-located transmitter could be a Bluetooth transmitter. One type of packet that can be transmitted by Bluetooth transmitters is SCO packets. SCO (Synchronous Connection Oriented) packets are used for connections of a circuit-switched nature, i.e. for reserved bandwidth communications. SCO packets are commonly used for transmitting real-time data such as voice data. Hence Bluetooth does not have a mechanism for retransmitting SCO packets.

One mechanism for coexistence between 802.11 ACKs and Bluetooth SCO packets might be to block sending of an ACK, or abort it if it has already begun to be transmitted, when there is a need to transmit a SCO packet. This has the disadvantage that the 802.11 transmitter will not receive the ACK and will begin some form of retransmission or fall-back behaviour, degrading 802.11 throughput. However, it has the advantage that the SCO packet, which will not be retransmitted, is not impeded.

Another mechanism for coexistence between 802.11 ACKs and Bluetooth SCO packets might be to block sending of a SCO packet, or abort it if it has already begun to be transmitted, when there is a need to transmit an ACK. This has the disadvantage that all, or the remainder of, the SCO packet will be lost, with no possibility of retransmission. If the SCO packet is carrying voice data this may manifest itself as an interruption of the voice stream, reducing its intelligibility at the receiver. However, it has the advantage that 802.11 traffic can continue without interruption.

Since both of these mechanisms have disadvantages, there is a need for an improved mechanism for coexistence between protocols.

According to one aspect of the present invention there is provided a communication device having: a first communication unit for transmitting and/or receiving by a first protocol acknowledgements for data received by the device; a second communication unit for transmitting data units of a second protocol, the first and second protocols being such that the data units of the second protocol can interfere with the acknowledgements of the first protocol; and a controller configured to control the device such that, when a data unit of the second protocol is being transmitted by the second communication unit and the first communication unit is to transmit or receive an acknowledgement of the first protocol: the second communication unit interrupts the transmission of the data unit of the second protocol, the first communication unit transmits or receives the acknowledgement of the first protocol and the second transmitter resumes transmission of the data unit of the second protocol from the point that transmission of the data unit would have reached if it had not been interrupted.

According to a second aspect of the invention there is provided a method for controlling a communication device having: a first communication unit for transmitting and/or receiving by a first protocol acknowledgements for data received by the device; a second communication unit for transmitting data units of a second protocol, the first and second protocols being such that the data units of the second protocol can interfere with the acknowledgements of the first protocol; and the method comprising controlling the device such that, when a data unit of the second protocol is being transmitted by the second communication unit and the first communication unit is to transmit or receive an acknowledgement of the first protocol: the second communication unit interrupts the transmission of the data unit of the second protocol, the first communication unit transmits or receives the acknowledgement of the first protocol and the second transmitter resumes transmission of the data unit of the second protocol from the point that transmission of the data unit would have reached if it had not been interrupted.

According to a third aspect of the present invention there is provided a communication device having: a first communication unit for transmitting by a first protocol acknowledgements for non-delay-critical data received by the device; a second communication unit for receiving data units of a second protocol, the data units of the second protocol carrying delay-critical data and the first and second protocols being such that the data units of the second protocol can interfere with the acknowledgements of the first protocol; and a controller configured to control the device such that, when a data unit of the second protocol is being received by the second communication unit and the first communication unit is to transmit an acknowledgement of the first protocol for non-delay-critical data received by the device the first communication unit interrupts the reception by the second communication unit of the data unit of the second protocol by transmitting the acknowledgement of the first protocol.

According to a fourth aspect of the present invention there is provided a method for controlling a communication device having: a first communication unit for transmitting by a first protocol acknowledgements for non-delay-critical data received by the device; and a second communication unit for receiving data units of a second protocol, the data units of the second protocol carrying delay-critical data and the first and second protocols being such that the data units of the second protocol can interfere with the acknowledgements of the first protocol; the method comprising controlling the device such that, when a data unit of the second protocol is being received by the second communication unit and the first communication unit is to transmit an acknowledgement of the first protocol for non-delay-critical data received by the device the first communication unit interrupts the reception by the second communication unit of the data unit of the second protocol by transmitting the acknowledgement of the first protocol.

The first protocol may be such that the data received by the device may be or is required or expected to be retransmitted if the acknowledgement is not successfully received by a transmitter of that data.

The first protocol may be an IEEE 802.11 protocol. The acknowledgement may be an IEEE 802.11 acknowledgement frame.

The second protocol may provide for only a limited number of retransmissions of the data unit of the second protocol if it is not successfully received by a recipient of that data unit. That limited number may be zero, one, two or more.

The second protocol may be such that traffic data contained in the portion of the data unit that is transmitted after the transmission of the acknowledgement can be recovered by a receiver of the data unit in spite of the said interruption.

The second protocol may be Bluetooth. The data unit may be a Bluetooth SCO or eSCO packet.

The interruption of the transmission of the data unit of the second protocol may be performed by disconnecting at least part of the second communication unit from an antenna. That antenna may be an antenna from which the second communication unit could otherwise transmit the data unit.

The interruption of the transmission of the data unit of the second protocol may be performed by transmitting the acknowledgement of the first protocol at a sufficiently high power as to mask part of the data unit of the second protocol.

The device may comprise an antenna that is usable by both the first and second communication units.

The controller may be configured to control the device such that, when a data unit of the second protocol is to be transmitted by the second communication unit and an acknowledgement of the first protocol is to be transmitted or received by the first communication unit: the second communication unit begins transmission of the data unit of the second protocol without the acknowledgement having been transmitted or received and then interrupts the transmission of the data unit of the second protocol whilst the first communication unit transmits or receives the acknowledgement of the first protocol.

The second communication unit may comprise a signal receiver section for receiving radio signals and a decoder section for decoding the radio signals received by the signal receiver section to form a series of decoded data values. The communication device may be configured to modify the manner of reception by the second communication unit during the transmission of an acknowledgement by the first communication unit so as to reduce the dependence of the decoded data values on the radio signals received by the signal receiver section.

The communication device may be configured to modify the manner of reception by the second communication unit during the transmission of an acknowledgement by the first communication unit by inputting dummy data instead of the received radio signals to the decoder section.

The present invention will now be described by way of example with reference to the accompanying drawings. In the drawings:

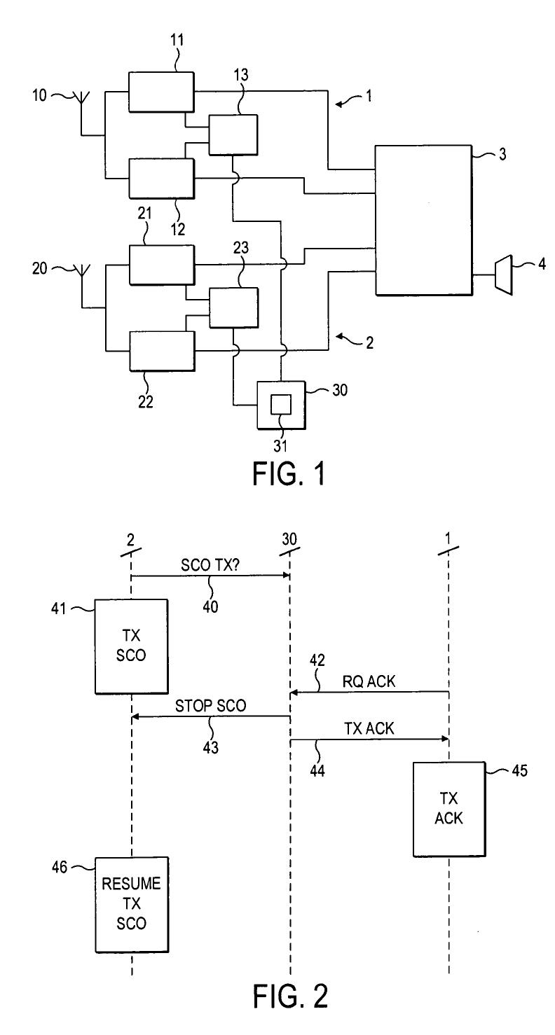

FIG. 1 shows a first device having 802.11 and Bluetooth transceivers;

FIG. 2 illustrates timing of 802.11 and Bluetooth transmissions; and

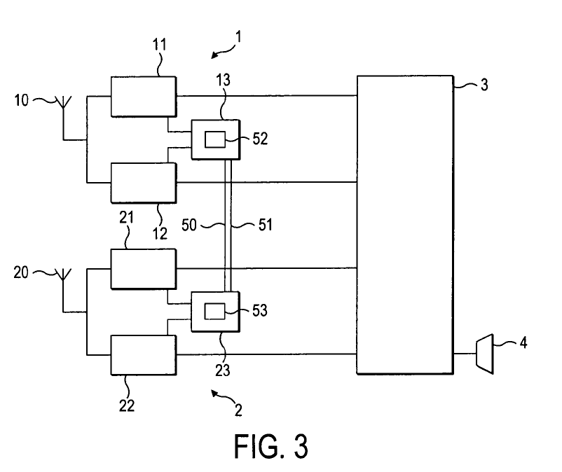

FIG. 3 shows a second device having 802.11 and Bluetooth transceivers.

The device of FIG. 1 implements a coexistence mechanism for reducing interference between an 802.11 transceiver 1 and a Bluetooth transceiver 2 that are co-located in the same device. In the receiver of FIG. 1, if a Bluetooth SCO packet is being transmitted when the time comes to transmit and 802.11 ACK then the SCO packet is temporarily interrupted whilst the ACK is transmitted. When the ACK has been transmitted transmission of the SCO packet is resumed at the same point that it would have reached if there had been no interruption. This will cause some Bluetooth data to be lost. However, the Bluetooth receiver for which the SCO packet was intended can still receive some of the SCO packet and may well be able to recover the traffic data contained in it because of the nature of the Bluetooth protocol.

In more detail, the device of FIG. 1 comprises a central processor 3 which can communicate with the transceivers 1 and 2. The central processor acts on traffic data received from either transceiver and forms traffic data for transmission by the transceivers. In the example of FIG. 1, the device includes a microphone 4. One function of the device is to forward audio data received from the microphone over a Bluetooth link. To do this, audio data from the microphone is packaged by the central processor 3 and then passed to the Bluetooth transceiver 2 for transmission.

The 802.11 transceiver comprises an antenna 10. A receiver 11 and a transmitter 12 are connected to the antenna. The receiver and the transmitter are also connected to the central processor 3 for respectively sending received data to the central processor and receiving from the central processor data for transmission. An 802.11 transceiver controller 13 is connected to the transmitter and the receiver and performs control functions for the 802.11 transceiver.

The Bluetooth transceiver comprises an antenna 20. A receiver 21 and a transmitter 22 are connected to the antenna. The receiver and the transmitter are also connected to the central processor 3 for respectively sending received data to the central processor and receiving from the central processor data for transmission. A Bluetooth transceiver controller 23 is connected to the transmitter and the receiver and performs control functions for the Bluetooth transceiver.

In practice the transceivers 1 and 2 may share a single antenna, and indeed that may contribute to the need for a coexistence algorithm between the two.

In the device of FIG. 1 there is also a coexistence controller 30. The coexistence controller has bidirectional communication with the controllers 13 and 23. It receives from each controller information about the current and desired activities of its respective transceiver, processes that data in accordance with a coexistence algorithm stored in memory 31 and sends instructions to the controllers 13 and 23 to instruct them how to behave in accordance with that algorithm.

When the Bluetooth transceiver is about to transmit a SCO packet it signals that fact to the coexistence controller 30. If the 802.11 transceiver has not signalled a desire to perform any conflicting activity then the coexistence controller permits the Bluetooth transceiver to transmit the SCO packet. If the 802.11 transceiver does not signal a desire to perform any conflicting activity during the whole duration of the SCO packet then the SCO packet will be transmitted uninterruptedly, as is normal. However, if whilst the SCO packet is being transmitted the 802.11 transceiver signals to the coexistence controller a request to transmit an ACK then the coexistence controller signals the Bluetooth transceiver to interrupt transmission for the duration of the ACK. The Bluetooth transceiver will respond by ceasing its transmissions immediately before the ACK begins and (if the SCO packet would not have ended by that point) resuming its transmissions immediately after the ACK ends.

This approach will result in some of the SCO packet being lost, but the lost data might be recoverable and in any event when the SCO packet is carrying audio data the brief interruption is likely only to cause limited audio degradation. This behaviour is possible because—provided the header of a SCO packet has been successfully decoded—the SCO packet can be successfully handled even with uncorrectable bit errors, and the Bluetooth CVSD codec is able to cope with errors.

That latter possibility is illustrated in FIG. 2. At step 40 the Bluetooth transceiver 2 signals the coexistence controller 30 that it is about to transmit a SCO packet. Since the 802.11 transceiver 1 does not at that moment intend any conflicting activity the coexistence controller permits the Bluetooth transceiver to begin transmitting the packet, which it does in step 41. The 802.11 transceiver then finishes processing some received 802.11 data and requests to the coexistence controller the sending of an ACK for that data. (Step 42). In response the coexistence controller signals the Bluetooth transceiver to cease transmissions for the known duration of the 802.11 ACK (step 43) and signals the 802.11 transceiver to transmit the ACK (step 44). The duration of the 802.11 ACK depends on the modulation scheme being used, but for 802.11b and 802.11g it can be between 44 to 304 μs. The 802.11 transceiver transmits the ACK. (Step 45). When the duration of the ACK has elapsed the Bluetooth transceiver resumes transmission of the SCO packet. (Step 46). The signalling scheme illustrated in FIG. 2 is just one example of the schemes that could be used.

When a SCO packet is interrupted to allow an ACK to be sent, its transmission is preferably interrupted as shortly as possible before the ACK begins. This timing will depend on the signalling scheme that is in use.

When a SCO packet is resumed after an ACK has been sent, its transmission is preferably resumed as soon as possible after the ACK ends. This timing will depend on the signalling scheme that is in use. The SCO packet is preferably resumed at the same point that it would have been at if there had been no interruption. This allows the receiver to maintain synchronisation with the packet. If the SCO packet would have ended by the time the ACK ends then there is no need to resume transmission of the SCO packet.

Bluetooth SCO packets and 802.11 ACKs cannot be significantly delayed. However, in implementations for other protocols in which the analogues of the SCO packets and the 802.11 ACKs can be delayed then additional implementations are possible. The analogue of the SCO packet could be delayed if the ACK would be sent at a time that overlaps with the header of the analogue of the SCO packet. However, it is preferred that in that situation the ACK is not sent or at least is delayed, with the result that the header of the analogue of the SCO packet is not interrupted. This may result in some unnecessary retransmission of packets for which ACKs have not been transmitted, but this may yield better overall performance in many situations since if the header of a packet is lost then it is normally very difficult—if not impossible—for the receiver to decode the packet.

The interruption may be implemented by blocking Bluetooth transmission at any suitable level, for example before signals reach the radio frequency section, or by a switch in the radio frequency section. In one preferred embodiment the Bluetooth modem is allowed to continue operation whilst the ACK is being transmitted, allowing Bluetooth activity to be resumed especially rapidly when the transmission of the ACK is complete.

FIG. 3 shows an alternative embodiment that avoids the need for the coexistence controller. Other components are numbered as in FIG. 1. In the embodiment of FIG. 3 the transceivers 1 and 2 signal each other directly via lines 50, 51 when they intend to perform transmission activity. The controllers 13 and 23 are programmed by the storage of instructions in memories 52, 53 to autonomously implement a selected coexistence algorithm. When the 802.11 transceiver is about to transmit an ACK, its controller 13 signals that fact to the controller 23 of the Bluetooth transceiver. In response to that signal, if the Bluetooth transceiver is currently transmitting a SCO packet then the controller 23 of the Bluetooth transceiver causes the packet to be interrupted in the manner described above.

In the embodiments of FIGS. 1 and 3 performance can be improved by using an RF architecture that supports simultaneous operation of the 802.11 and Bluetooth transceivers. This could involve separate antennas for each transceiver or a single antenna shared via a coupler rather than a switch. Such an architecture can better support simultaneous transmission of SCO and ACKs, although reception of SCO packets will still be affected by transmission of ACKs unless significant isolation can be achieved.

The coexistence algorithms implemented in the devices of FIGS. 1 and 3 could have other aspects not described above. For example, if the 802.11 transceiver wants to send an ACK when the Bluetooth transceiver is transmitting a packet other than a SCO packet then the means that implements the coexistence algorithm could be configured to terminate transmission of the Bluetooth packet and not resume it as could be done if it were a SCO packet.

The 802.11 transceiver could conveniently signal its intention to send an ACK packet using any suitable protocol, including by sending an established or standardised form of coexistence signal to the Bluetooth transceiver.

The principles described above could be applied to pairs of protocols other than 802.11 and Bluetooth. In a more generalised situation a “first” protocol could equate to 802.11 in the above examples and a “second” protocol could equate to Bluetooth in the above examples. The first protocol and the second protocol share channel space (e.g. in the frequency or code domains) such that at least some activity of the second protocol interferes with acknowledgement messages or other throughput-influencing messages of the first protocol. That activity of the second protocol involves the transmission of data units that carry time-critical data and/or that are not the subject of a retransmission protocol if mis-received. Those data units are such that they have or can have a longer duration than one of the said messages of the first protocol, and are subject to an encoding scheme that is such that if one such data unit is interrupted at least some of the traffic data carried before (or possibly after) the resumption can be at least partially recovered by a receiver in spite of the interruption.

The interruption of Bluetooth transmissions could be implemented in a number of ways.
1. One or more of the Bluetooth baseband, intermediate frequency or radio frequency components could halt operation, with the result that Bluetooth RF signals no longer reach an antenna to which they would normally pass.
2. All the dedicated Bluetooth components could continue to generate a Bluetooth signal, but a switch between the dedicated Bluetooth components and the antenna could interrupt the Bluetooth signals, preventing their transmission. This approach is especially convenient when the Bluetooth and 802.11 transceivers share an antenna, or share both an antenna and an RF front-end. To interrupt Bluetooth transmissions the switch could be set to connect the dedicated 802.11 components to the shared part of the path. This approach has the advantage that the Bluetooth components can operate as normal, with the interruption associated with the present system being implemented merely by controlling the switch.
3. 802.11 signals are typically transmitted at much higher power than Bluetooth signals. Rather than being interrupted by virtue of their not being transmitted, the Bluetooth signals could be interrupted by virtue of their being swamped by simultaneous 802.11 transmission from the device. In this embodiment, the Bluetooth components could continue as normal, even transmitting a signal during the interruptions, but that signal will not be received because of powerful interference from the co-located 802.11 transmitter. In the present system this may happen even if the Bluetooth device is transmitting a SCO packet, which would normally benefit from protection against interference from other co-located transmitters.
4. Instead of interrupting all transmission during the interruption of a SCO frame, the Bluetooth transceiver could transmit dummy data during the interruption, for example a stream of dummy symbols or bits of the same type or that cycle in a predetermined manner. This could inherently increase the chances that the receiver can decode the end portion of the SCO packet. Also, the intended Bluetooth receiver could be programmed to be aware that the Bluetooth transmitter will adopt this behaviour. If the Bluetooth receiver then identifies by decoding a string of such data in a SCO packet, that a SCO packet has been interrupted in that way then it could treat that data as being invalid rather than try to decode it, increasing the chance that it will validly decode the end portion of the packet.

The principles described above could be applied during reception of SCO packets or like data units. When a protected SCO packet is being received, that reception could be interrupted to allow an 802.11 ACK to be sent. The interruption could be performed by switching out the Bluetooth receiver, e.g. by disconnecting it from a shared antenna, or by transmitting the ACK in such a way that it prevents accurate reception of the SCO packet during transmission of the ACK. If the latter method is adopted then strategies could be employed to improve decoding of the interrupted SCO packet.

Thus, if the Bluetooth transceiver is receiving a SCO packet when the 802.11 ACK is to be sent from the co-located 802.11 transceiver then that reception could be interrupted, or any data received in that period marked as invalid, and reception of the SCO packet could be resumed when the ACK has been sent. This may be done despite the fact that SCO packets typically carry delay-critical data (e.g. voice data) and the 802.11 data that is being acknowledged might not be delay-critical. The reason for this is that the start and potentially the end of the SCO packet can still be usable despite the interruption. In a typical receiver the radio frequency signal is received by an RF front end, which then passes a signal dependent on the RF signal to a decoder in order to determine what symbols were carried in the RF signal. It can be advantageous to reduce the dependence of the Bluetooth decoder on the received RF signal during an interruption, so as to improve the usability of the uninterrupted portion of the SCO packet. This may be done by providing to the decoder dummy data rather than data dependent on the received RF signal during the interruption, or by tagging the RF data received during the interruption as being less reliable.

The approaches described above can also be applied to eSCO packets. eSCO packets can be retransmitted a limited number of times, but can be usefully handled even when part of the packet is missing or corrupt, and are not necessarily retransmitted until successful. The system can also be applied to other packets of a similar nature, for example those whose retransmission is limited, or that are time-critical, and that can be usefully handled even when partially received.

The device could be any suitable type of device, for example a mobile phone, a notebook computer, a domestic appliance or a motor car. One specific example of such a device is a mobile phone that transcodes between VoIP (Voice over Internet Protocol) via 802.11 and Bluetooth audio to a wireless headset.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A communication device having:
a first communication unit for transmitting and/or receiving by a first protocol acknowledgements for data received by the device;
a second communication unit for transmitting data units of a second protocol, the first and second protocols being such that the data units of the second protocol can interfere with the acknowledgements of the first protocol; and
a controller configured to control the device such that, when a data unit of the second protocol is being transmitted by the second communication unit and the first communication unit is to transmit or receive an acknowledgement of the first protocol: the second communication unit interrupts the transmission of the data unit of the second protocol, the first communication unit transmits or receives the acknowledgement of the first protocol and the second transmitter resumes transmission of the data unit of the second protocol from the point that transmission of the data unit would have reached if it had not been interrupted.

2. A communication device as claimed in claim 1, wherein the first protocol is such that the data received by the device may be retransmitted if the acknowledgement is not successfully received by a transmitter of that data.

3. A communication device as claimed in claim 1, wherein the first protocol is an IEEE 802.11 protocol and the acknowledgement is an IEEE 802.11 acknowledgement frame.

4. A communication device as claimed in any preceding claim, wherein the second protocol provides for only a limited number of retransmissions of the data unit of the second protocol if it is not successfully received by a recipient of that data unit.

5. A communication device as claimed in any preceding claim, wherein the second protocol is such that traffic data contained in the portion of the data unit that is transmitted after the transmission of the acknowledgement can be recovered by a receiver of the data unit in spite of the said interruption.

6. A communication device as claimed in any preceding claim, wherein the second protocol is Bluetooth and the data unit is a Bluetooth SCO or eSCO packet.

7. A communication device as claimed in any preceding claim, wherein the interruption of the transmission of the data unit of the second protocol is performed by disconnecting at least part of the second communication unit from an antenna.

8. A communication device as claimed in any preceding claim, wherein the interruption of the transmission of the data unit of the second protocol is performed by transmitting the acknowledgement of the first protocol at a sufficiently high power as to mask part of the data unit of the second protocol.

9. A communication device as claimed in any preceding claim, the device comprising an antenna that is usable by both the first and second communication units.

10. A communication device as claimed in any preceding claim, wherein the controller is configured to control the device such that, when a data unit of the second protocol is to be transmitted by the second communication unit and an acknowledgement of the first protocol is to be transmitted or received by the first communication unit: the second communication unit begins transmission of the data unit of the second protocol without the acknowledgement having been transmitted or received and then interrupts the transmission of the data unit of the second protocol whilst the first communication unit transmits or receives the acknowledgement of the first protocol.

11. A method for controlling a
communication device having:
a first communication unit for transmitting and/or receiving by a first protocol acknowledgements for data received by the device;
a second communication unit for transmitting data units of a second protocol, the first and second protocols being such that the data units of the second protocol can interfere with the acknowledgements of the first protocol; and
the method comprising controlling the device such that, when a data unit of the second protocol is being transmitted by the second communication unit and the first communication unit is to transmit or receive an acknowledgement of the first protocol: the second communication unit interrupts the transmission of the data unit of the second protocol, the first communication unit transmits or receives the acknowledgement of the first protocol and the second transmitter resumes transmission of the data unit of the second protocol from the point that transmission of the data unit would have reached if it had not been interrupted.

12. A communication device having:
a first communication unit for transmitting by a first protocol acknowledgements for non-delay-critical data received by the device;
a second communication unit for receiving data units of a second protocol, the data units of the second protocol carrying delay-critical data and the first and second protocols being such that the data units of the second protocol can interfere with the acknowledgements of the first protocol; and
a controller configured to control the device such that, when a data unit of the second protocol is being received by the second communication unit and the first communication unit is to transmit an acknowledgement of the first protocol for non-delay-critical data received by the device the first communication unit interrupts the reception by the second communication unit of the data unit of the second protocol by transmitting the acknowledgement of the first protocol.

13. A communication device as claimed in claim 12, wherein the first protocol is such that the data received by the device will be retransmitted if the acknowledgement is not successfully received by a transmitter of that data.

14. A communication device as claimed in claim 12 or 13, wherein the first protocol is an IEEE 802.11 protocol and the acknowledgement is an IEEE 802.11 acknowledgement frame.

15. A communication device as claimed in any of claims 12 to 14, wherein the second protocol provides for only a limited number of retransmissions of the data unit of the second protocol if it is not successfully received by a recipient of that data unit.

16. A communication device as claimed in any of claims 12 to 15, wherein the second protocol is such that traffic data contained in a portion of the data unit that is received after the transmission of the acknowledgement can be recovered by the second communication unit in spite of the said interruption.

17. A communication device as claimed in any of claims 12 to 16, wherein the second protocol is Bluetooth and the data unit is a Bluetooth SCO or eSCO packet.

18. A communication device as claimed in any of claims 12 to 17, wherein the second communication unit comprises a signal receiver section for receiving radio signals and a decoder section for decoding the radio signals received by the signal receiver section to form a series of decoded data values, and wherein the communication device is configured to modify the manner of reception by the second communication unit during the transmission of an acknowledgement by the first communication unit so as to reduce the dependence of the decoded data values on the radio signals received by the signal receiver section.

19. A communication device as claimed in claim 18, wherein the communication device is configured to modify the manner of reception by the second communication unit during the transmission of an acknowledgement by the first communication unit by inputting dummy data instead of the received radio signals to the decoder section.

20. A communication device as claimed in any of claims 12 to 19, the device comprising an antenna that is usable by both the first and second communication units.

21. A method for controlling a communication device having: a first communication unit for transmitting by a first protocol acknowledgements for non-delay-critical data received by the device; and a second communication unit for receiving data units of a second protocol, the data units of the second protocol carrying delay-critical data and the first and second protocols being such that the data units of the second protocol can interfere with the acknowledgements of the first protocol;
The method comprising controlling the device such that, when a data unit of the second protocol is being received by the second communication unit and the first communication unit is to transmit an acknowledgement of the first protocol for non-delay-critical data received by the device the first communication unit interrupts the reception by the second communication unit of the data unit of the second protocol by transmitting the acknowledgement of the first protocol.
